(19) United States
(12) Patent Application Publication
(10) Pub. No.: US 2025/0376811 A1
(43) Pub. Date: Dec. 11, 2025

(54) COMPREHENSIVE CLIMATE ADAPTABILITY PERMAFROST SUBGRADE HYDROTHERMAL REGULATION SYSTEM

(71) Applicant: HARBIN INSTITUTE OF TECHNOLOGY, Harbin City (CN)

(72) Inventors: Hao Zheng, Harbin City (CN); Junling Si, Harbin City (CN); Daoju Ren, Harbin City (CN); Shaobing Fan, Harbin City (CN); Shanpeng Liu, Harbin City (CN); Yuanyuan Liu, Harbin City (CN); Mingze Li, Harbin City (CN)

(21) Appl. No.: 19/176,197

(22) Filed: Apr. 11, 2025

(30) Foreign Application Priority Data
Jun. 5, 2024 (CN) 2024107239835

(51) Int. Cl. E01C 3/06

(52) U.S. Cl. CPC E01C 3/06

(57) ABSTRACT

A comprehensive climate adaptability permafrost subgrade hydrothermal regulation system is provided. The system includes a wind-driven forced convection cooling plate, a wind-driven device, a thermal insulation layer and a capillary blocking covering layer, where the wind-driven forced convection cooling plate is laid at a bottom of a subgrade, and a slender channel is arranged in the plate; the wind-driven device is connected with the slender channel in the wind-driven forced convection cooling plate, and a liquid working medium is driven to flow in the slender channel by a pump; the thermal insulation layer is laid on an upper part of the wind-driven forced convection cooling plate; and the capillary blocking covering layer is laid on a slope.

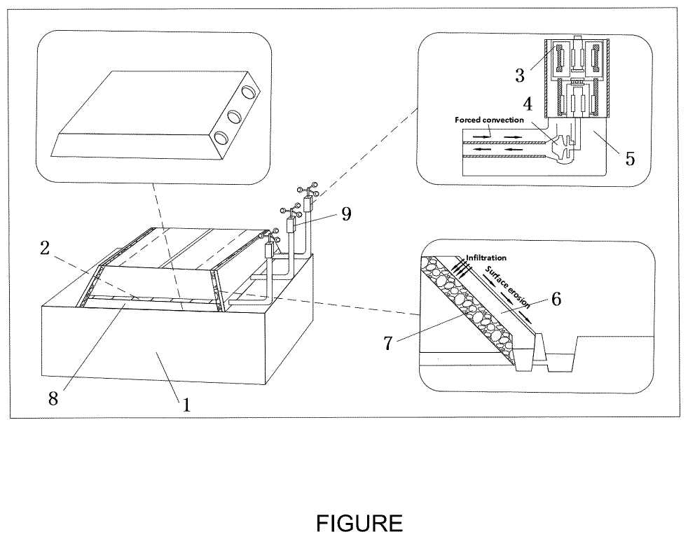

### CROSS-REFERENCE TO RELATED APPLICATIONS

This application claims priority to Chinese Patent disclosure No. 202410723983.5, filed on Jun. 5, 2024, the contents of which are hereby incorporated by reference.

### TECHNICAL FIELD

The disclosure belongs to the technical field of road engineering, and relates to a control system of permafrost subgrade, in particular to a comprehensive climate adaptability permafrost subgrade hydrothermal regulation system.

### BACKGROUND

The transportation infrastructure of Qinghai-Tibet Plateau is an important foundation to ensure the national strategic delivery capacity and the national border security. However, at present, the uneven thawing and settlement of permafrost sections of Qinghai-Tibet Plateau highway is serious, which seriously affects the service performance and traffic capacity of the road. Especially in the context of global warming and humidification, how to improve the service performance and durability of highway transportation infrastructure in Qinghai-Tibet Plateau, and reduce or even inhibit the thawing settlement of roads in high temperature frozen soil sections is an urgent engineering problem to be solved.

At present, the commonly used technical schemes include setting stone layers, hot rods, ventilation pipes, awnings/sunshading plates, and comprehensive control measures combined with various systems. By these means, the subgrade is cooled to achieve the cooling effect. The construction of block stone subgrade is simple and convenient, and the construction cost is relatively low. It can also reduce the difference of melting depth between yin and yang slopes and prevent uneven settlement and longitudinal cracking. However, due to the influence of the overlying soil layer, the cooling effect of the block stone subgrade is weakened, so other cooling measures are needed to ensure the stability of the subgrade in the high temperature frozen soil region. In areas with high temperature and high ice content, the effect of using hot rods to control subgrade diseases is remarkable. However, the cost of hot rods is high. At present, hot rods are usually placed on the shoulder, so it is difficult to cool the whole subgrade. The awnings/sunshading plates can not only block the direct radiation of the sun to the subgrade, but also prevent the slope from scouring and reduce the infiltration of rainwater into the subgrade. However, due to the large temperature difference in permafrost regions, the sunshading plate materials are prone to structural deformation and damage due to thermal expansion and contraction, and it is difficult to use them for a long time. Ventilation pipe subgrade can exchange heat between cold air and surrounding soil under the action of wind, but it may also become a passage for hot air in warm season. Therefore, a comprehensive climate adaptability permafrost subgrade hydrothermal regulation system is needed to ensure the long-term stability of subgrade in high temperature frozen soil regions.

### SUMMARY

The purpose of the disclosure is to provide a comprehensive climate adaptability permafrost subgrade hydrothermal regulation system, so as to solve the serious problem of uneven settlement diseases caused by thawing settlement of permafrost sections under the background of global warming and humidification.

The purpose of the present disclosure is achieved by the following technical scheme.

A comprehensive climate adaptability permafrost subgrade hydrothermal regulation system, including a wind-driven forced convection cooling plate, a wind-driven device, a thermal insulation layer and a capillary blocking covering layer, where the wind-driven forced convection cooling plate is laid at a bottom of a subgrade, and a slender channel is arranged in the plate; the wind-driven device is connected with the slender channel in the wind-driven forced convection cooling plate, and a liquid working medium is driven to flow in the slender channel by a pump, so that forced convection is realized; the thermal insulation layer is laid on an upper part of the wind-driven forced convection cooling plate to prevent high heat in summer from being transmitted to the subgrade and permafrost; and the capillary blocking covering layer is laid on a slope, and surface water is effectively isolated by using a principle of capillary barrier, so that the subgrade is in a dry state.

Compared with the prior art, the disclosure has the following advantages.

The disclosure adopts the wind-driven device to make the liquid working medium circulate in the steel pipe for forced convection. Compared with the conventional hot rod, it can provide more cooling power. In addition, the concrete material of the cooling plate conducts heat quickly, which can change point and line cooling into plane cooling and reduce the possibility of uneven settlement.

Compared with the conventional technology, the comprehensive climate adaptability permafrost subgrade hydrothermal regulation system provided by the disclosure can realize the annual climate adaptability. It not only enhances the cooling effect by forced convection in winter, but also slows down the heat transfer to subgrade and its lower permafrost in summer. At the same time, the system can also prevent road surface and ground runoff from invading the interior of subgrade, thus restraining uneven settlement of subgrade to the greatest extent.

### BRIEF DESCRIPTION OF THE DRAWING

The FIGURE is a schematic structural diagram of the comprehensive climate adaptability permafrost subgrade hydrothermal regulation system.

### DETAILED DESCRIPTION OF THE EMBODIMENTS

The technical scheme of the present disclosure will be further explained with the attached drawings, but it is not limited to this. Any modification or equivalent substitution of the technical scheme of the present disclosure without departing from the spirit and scope of the technical scheme of the present disclosure shall be included in the protection scope of the present disclosure.

The disclosure provides a comprehensive climate adaptability permafrost subgrade hydrothermal regulation system. As shown in the FIGURE, the regulation system includes a wind-driven forced convection cooling plate 8, a wind-driven device 9, a thermal insulation layer 2 and a capillary blocking covering layer, where the wind-driven forced convection cooling plate 8 is laid at the bottom of the subgrade, and a slender channel is arranged in the plate. Among them, the wind-driven forced convection cooling plate 8 adopts cement concrete plate or fine sand. The slender channel is made of materials with good thermal conductivity and high strength, such as steel pipes.

The thermal insulation layer 2 is laid on the surface of the wind-driven forced convection cooling plate 8, and the material of the thermal insulation layer 2 is extruded polystyrene foam material (XPS) or polyurethane insulation plate.

The capillary blocking covering layer is laid on the slope and consists of two soil layers with different grain sizes: coarse-grained soil layer 7 and fine-grained soil layer 6. By using the principle of capillary barrier, surface water can be effectively isolated, so that the subgrade is in a dry state. Among them, fine gravel is used for coarse-grained soil layer 7 and silt is used for fine-grained soil layer 6.

The wind-driven device 9 is spliced with the slender channel inside the wind-driven forced convection cooling plate 8.

In the present disclosure, the wind-driven forced convection cooling plate 8 promotes the flow of liquid in the channel by forced convection. This design uses wind energy as the power source, and through the slender channel designed inside wind-driven forced convection cooling plate 8, liquid can generate convection in it. When cold air flows through the wind-driven device 9, the wind-driven device 9 will be turned on through the frost heaving clutch 3 to drive the lower pump 4 to run to realize the flow of liquid in the channel, and then take away the heat around the wind-driven forced convection cooling plate 8, thereby reducing the temperature of the subgrade.

In the present disclosure, the purpose of the thermal insulation layer 2 is to slow down the heat transfer to the subgrade and the permafrost 1 under the subgrade, which can be achieved by using the thermal insulation layer 2 in the continuous permafrost region where the annual average temperature under the subgrade is lower than 0 degree Celsius (° C.). The function of thermal insulation layer 2 in subgrade is to prevent heat conduction from flowing to active layer. Therefore, the temperature of frozen soil will remain relatively low in summer, and the degradation of frozen soil may be reduced. However, the thermal insulation layer 2 has the same effect in blocking heat flow in winter. During this period, the thermal insulation layer 2 and the wind-driven forced convection cooling plate 8 play a comprehensive role, and the wind-driven forced convection cooling plate 8 mainly lowers the temperature of subgrade and frozen soil below the thermal insulation layer 2, so as to maximize its effect.

According to the disclosure, the capillary blocking covering layer utilizes the principle of capillary barrier, and controls the movement of moisture in the soil through specially designed structures and materials, so as to prevent moisture from permeating upward to the subgrade surface through capillary action. By constructing such a barrier in the subgrade, groundwater and surface water can be effectively isolated, thus keeping the subgrade dry.

In one embodiment, the main technical parameters of the comprehensive climate adaptability subgrade hydrothermal regulation system are as follows. The wind-driven forced convection cooling plate is made of cement concrete plate or fine sand with a thickness of 15 centimeters (cm). A wind-driven device is arranged at intervals of 2 meters (m). The wind-driven device is spliced with the channel inside the wind-driven forced convection cooling plate, and the channel is a steel pipe with a diameter of 8 cm. The thermal insulation layer is made of XPS insulation plate with a thickness of 6 cm. The design of capillary blocking covering layer is composed of two soil layers with different grain sizes, with a total thickness of 60 cm. Among them, coarse-grained soil is made of fine gravel with a thickness of 20 cm, and fine-grained soil is made of silt with a thickness of 40 cm.

The specific construction method is as follows.

1. Preparing the site: determining the boundary of subgrade construction, clearing the surface vegetation, digging out the roots, removing the original ground surface soil, removing the soft soil within the subgrade, backfilling with stable soil and stone, and compacting or tamping.

2. Placing precast cement concrete plate: paving a gravel layer as the foundation layer of precast cement concrete plate, so that the paved gravel can be fully compacted by compaction machinery. Hoisting the precast cement concrete plate to the designated position by using lifting machinery to ensure that all precast cement concrete is aligned correctly.

3. Laying thermal insulation layer: XPS insulation plate is laid in the form of flat joint or staggered joint lap, and the plates are close together to avoid a big gap in the middle. After the XPS plate is laid for a certain distance, a layer of waterproof geotextile is laid on the plate to keep the tightness between XPS and prevent the ground water from entering the subgrade.

4. Paving the filling on the insulation plate: in order to ensure that the insulation plate is not damaged in the rolling process, the soil with smaller grain size such as sand gravel is used as the filling on the plate, and the backward paving method is adopted, that is, the material truck unloads the material at the first section of the insulation plate subgrade to form a dense pile, and then the bulldozer pushes the filling forward according to the reserved compaction thickness, and so on, to complete the paving of the filling on the plate.

5. Filling and compacting subgrade: unloading according to the loose paving thickness of each layer of 30 cm, using a loader for initial paving, and rolling back and forth on the leveled filling to complete the initial compaction. Then the grader is used for leveling, and after the initial leveling of each layer is completed, a certain road arch is formed to facilitate drainage. Manual leveling shall be adopted for corners that cannot be reached by machinery. After leveling is completed, it will be rolled, and static pressure will be used for initial compaction, and then it is changed to vibration compaction.

6. Laying the capillary blocking covering layer: after the subgrade soil layer is compacted and reaches the required strength, a layer of coarse-grained soil layer is laid on the slope, and then a layer of fine-grained soil layer is covered and compacted.

7. Installing the wind-driven device: after the steel pipe is filled with cooling liquid, the wind-driven device is spliced with the steel pipe immediately.

What is claimed is:

1. A comprehensive climate adaptability permafrost subgrade hydrothermal regulation system, comprising a wind-driven forced convection cooling plate, a wind-driven device, a thermal insulation layer and a capillary blocking covering layer, wherein:
the wind-driven forced convection cooling plate is laid at a bottom of a subgrade, and a slender channel is arranged in the plate;
the wind-driven device is connected with the slender channel in the wind-driven forced convection cooling plate, and a liquid working medium is driven to flow in the slender channel by a pump, so that forced convection is realized;
the thermal insulation layer is laid on an upper part of the wind-driven forced convection cooling plate to prevent high heat in summer from being transmitted to the subgrade and permafrost; and
the capillary blocking covering layer is laid on a slope, and surface water is effectively isolated by using a principle of capillary barrier, so that the subgrade is in a dry state.

2. The comprehensive climate adaptability permafrost subgrade hydrothermal regulation system according to claim 1, wherein the wind-driven forced convection cooling plate adopts cement concrete plate or fine sand.

3. The comprehensive climate adaptability permafrost subgrade hydrothermal regulation system according to claim 1, wherein the thermal insulation layer is made of an XPS or a polyurethane insulation plate.

4. The comprehensive climate adaptability permafrost subgrade hydrothermal regulation system according to claim 1, wherein the capillary blocking covering layer is composed of a coarse-grained soil layer and a fine-grained soil layer.

5. The comprehensive climate adaptability permafrost subgrade hydrothermal regulation system according to claim 4, wherein the coarse-grained soil layer adopts fine gravel.

6. The comprehensive climate adaptability permafrost subgrade hydrothermal regulation system according to claim 4, wherein the fine-grained soil layer adopts silt.
